(19) United States
(12) Patent Application Publication
(10) Pub. No.: US 2026/0114447 A1
(43) Pub. Date: Apr. 30, 2026

(54) ADHESIVE OR COATING WITH ANTI-MICROBIAL AND NATURAL PESTICIDES

(71) Applicant: GTACK LLC, Port Washington, NY (US)

(72) Inventor: Greg John HOVSEPIAN, Port Washington, NY (US)

(73) Assignee: GTACK LLC, Port Washington, NY (US)

(21) Appl. No.: 19/360,136

(22) Filed: Oct. 16, 2025

Related U.S. Application Data
(60) Provisional application No. 63/711,493, filed on Oct. 24, 2024.
(60) Provisional application No. 63/718,823, filed on Nov. 11, 2024.
(60) Provisional application No. 63/725,957, filed on Nov. 27, 2024.

(51) Int. Cl. A01N 37/10; A01N 25/02; A01N 65/22; A01N 65/28; A01P 17/00; C09J 11/06; C09J 103/02

(52) U.S. Cl. CPC A01N 37/10; A01N 25/02; A01N 65/22; A01N 65/28; A01P 17/00; C09J 11/06; C09J 103/02

(57) ABSTRACT

An adhesive, and/or a biopolymer that contains Cinnamon and/or cinnamic acid, Tee Tree Oil. Rosemary or other natural essential oil or essence. In at least one embodiment the wt % of Cinnamon is 0.4%. In at least one embodiment the wt % of cinnamic acid is at least 5%. In at least one embodiment the wt % of cinnamic acid is 7%. In at least one embodiment the wt % of cinnamic acid is at least 10%. In addition, there is a process for applying a natural biocide. The adhesive can be combined with paper products, corrugated cardboard or building materials such as wood panels.

### CROSS REFERENCE TO RELATED APPLICATIONS

This application is a non-provisional application which claims priority from provisional application Ser. No. 63/711,493 filed on Oct. 24, 2024, this application also claims priority from provisional application Ser. No. 63/718,823 filed on Nov. 11, 2024. This application also claims priority from provisional application 63/725,957 filed on Nov. 27, 2024, the disclosure of these applications are hereby incorporated herein by reference in their entirety.

### BACKGROUND OF THE INVENTION

One embodiment of the invention relates to an adhesive and/or coating with anti-microbial and/or natural pesticide properties. There is also a process for applying this type of adhesive and/or coating to common packaging, such as cardboard or display packaging, and/or paper products. In at least one embodiment, the adhesive and/or coating can include cinnamon, cinnamic acid, tea tree oil, rosemary, or other essential Oils are used as a natural pesticide.

This type of compound can be combined or applied to starch-based adhesives and to biopolymers. The use of biopolymers and starch-based adhesives dates back centuries. In ancient times, natural adhesives such as plant resins and animal glues were commonly used to bind fibers together. Starch, derived from various sources including maize, potatoes, and rice, was also used as a sizing agent to improve the strength and smoothness of paper, then cardboard and paperboard. Starch serves as an economically and environmentally friendly adhesive in the packaging industry. The use of biopolymers in the packaging industry is prevalent due to their unparalleled strength. Biopolymers are the main ingredient in the bonding agent used to corrugate paper. They are also used as a finishing bonding agent in the folding and gluing process. Starch accounts for 20-25% of the weight of ingredients used for a biopolymer adhesive.

Biopolymers and adhesives are applied in a variety of ways. In the corrugation process, a series of paper rolls are merged and laminated to each other. A heated corrugated roll is used to apply flutes to one of the webs of paper, the medium. The adhesive is applied to the tips of the flutes to adhere to the outer liners and the medium liner. In this process, the adhesive is cured by extreme pressures and temperatures. For the finishing of corrugated paperboard and paperboard, adhesives are extruded through various applicators at strategic volumes to the substrate and then folded using strategically placed belts and tools. The belts provide movement and pressure for the adhesive to cure; sometimes, additional intervention is needed to cure the adhesive. Molded paper pulp is another method of using paper as a packaging material. In this process, a slurry of paper-based pulp is conformed to the shape of a specific molding die and cured with extreme pressures and temperatures.

Corrugated paperboards are presently manufactured in a continuous operation involving several steps. A strip of paper, slightly moistened, is passed through heated flute rolls. To one side of the heated fluted paper, adhesive is applied to the tip edge of each flute. Immediately thereafter, a strip of liner paper is brought into contact with the adhesive-treated flutes of the corrugated paper in the presence of heat and pressure resulting in the formation of a strong adhesive bond. This product is known in the art as “single face” corrugated paperboard.

Another type of corrugated paperboard is “double face”. The double face is prepared by applying adhesive to the exposed flutes of the single face board and bonding a second liner to the adhesive-tipped flutes. The application of the second liner is more difficult than that of the first liner because less pressure can be applied during the setting and bonding of the adhesive lest the corrugated strip be crushed. Because less pressure is available for bonding the second liner to the flutes, it is sometimes necessary to use a slightly different formulation for the attachment of the second liner. Therefore, there is a need for an adhesive or biopolymer that can be used in consumer products and/or the food industry that has a natural biocide that is not harmful to humans.

### SUMMARY

At least one embodiment of the invention relates to at least one of an adhesive, and/or a biopolymer that contains Cinnamon and/or cinnamic acid, Tea Tree Oil. Rosemary, Oregano Oil Powder, which is an oil extracted from the oregano plant (Origanum vulgare) in the form of a dry powder made by microencapsulation technology or other natural essential oils or essence. In at least one embodiment, the weight percentage (wt %) of Cinnamon is 0.4%. In at least one embodiment, the weight percentage (wt %) of cinnamic acid is at least 5%. In at least one embodiment, the weight percentage (wt %) of cinnamic acid is 7%. In at least one embodiment, the weight percentage (wt %) of cinnamic acid is at least 10%. Additionally, a process exists for applying a natural biocide.

Cinnamic acid is an organic compound with the formula C6H5—CH═CH—COOH. It is a white crystalline compound that is slightly soluble in water, and freely soluble in many organic solvents. Classified as an unsaturated carboxylic acid, it occurs naturally in a number of plants. It exists as both a cis and a trans isomer, although the latter is more common. It is obtained from cinnamon oil, or from balsams such as storax. It is also found in shea butter. Cinnamic acid has a honey-like odor, and its more volatile ethyl ester, ethyl cinnamate, is a flavor component in the essential oil of cinnamon, which related cinnamaldehyde is the major constituent. It is also found in wood from many diverse tree species.

In at least one embodiment, there is an insecticide solution comprising: at least 1 wt % cinnamic acid and at least one additional oil comprising at least one of tea tree oil, rosemary oil, cedar oil, or powdered oregano oil.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1A is a view of a first embodiment of components for making corrugated material for use in packaging with the coating or adhesive applied;

FIG. 1B is a view of another embodiment of the components for making a corrugated material;

FIG. 1C is a view of another embodiment of the components for making a corrugated material;

FIG. 2 is a view of another embodiment of the components for making corrugated material for use in packaging with the coating or adhesive applied;

FIG. 3A is a view of the corrugated material;

FIG. 3B is another view of another embodiment of corrugated material;

FIG. 3C is another view of the corrugated material with the outer covers removed;

FIG. 4 is a view of the components for coating the outer covers of the corrugated material;

FIG. 5 is a view of the flow chart for applying the adhesive and/or coating to the packaging material;

FIG. 6 is a flow chart for the process for adding the insecticide to an adhesive to oriented strand board;

FIG. 7 is a flow chart for the process of adding the insecticide to an adhesive to paper pulp manufacturing;

FIG. 8A is a view of the box with the adhesive;

FIG. 8B is a side view of the adhesive strip;

FIG. 9A is a side perspective view of the nozzle applicator;

FIG. 9B is a side perspective view of another embodiment of the nozzle applicator; and

FIG. 9C is another side perspective view of the nozzle applicator,

FIG. 10 is a view of a blank;

FIG. 11 is a flow chart for the process for creating a soft sided enclosure having cinnamic acid; and

FIG. 12 is a process for applying the cinnamic acid to a sack.

### DETAILED DESCRIPTION

In at least one embodiment, an insecticide is disclosed in Example 1. In another embodiment, the insecticide can be mixed with the raw starch prior to mixing the adhesive. In another embodiment, there is an adhesive which is infused with an insecticide described below in Example 2:

Example 3. At various concentrations within the effective working percentage of the active ingredient, the adhesion characteristics of the adhesive can increase.

### Example 1

An Insecticidal Adhesive is created, comprising 4 to 11% Cinnamon or Cinnamic acid, with or without the addition of other organic essentials, such as Tea Tree Oil, Oregano Oil Powder, which is a volatile oil extracted from the oregano plant (Origanum vulgare) in the form of a dry powder made by microencapsulation technology. Rosemary Oil or essence, Cedar Oil

### Example 2

A starch and water slurry was prepared by admixing 35-40% of 130° F. water with 2.8% unmodified, ungelatinized corn starch, followed by the addition of an additional 3% of water. To this slurry, 0.1-0.15% caustic (NaOH) was added at 170° F. The mixture was agitated and allowed to react for 15 minutes. Water in the amount of 26-29% was added, combined with 0.4% of Borax and 5-10% of Cinnamic Acid (or other natural biocide listed in this invention), to which 23-25% of starch (of many varieties) was added, and the mixture was agitated for 15 minutes. The resulting corrugating adhesive paste had an initial Stein Hall cup viscosity of 33 seconds; after 2 hours, it was 32 seconds, and after 24 hours, it was 33 seconds. The gel point of the paste was 147-159° F.

### Example 3

A starch and water slurry was prepared by admixing 35-40% of 130° F. water with 2.8% unmodified, ungelatinized corn starch, followed by the addition of an additional 3% of water. To this slurry, 0.1-0.15% caustic (NaOH) was added at 170° F. The mixture was agitated and allowed to react for 15 minutes. Water in the amount of 26-29% was added, combined with 0.4% of Borax and 5-10% of Cinnamic Acid and 5-10% Powdered oregano oil (or other natural biocide listed in this invention), to which 23-25% of starch (of many varieties) was added, and the mixture was agitated for 15 minutes. The resulting corrugating adhesive paste had an initial Stein Hall cup viscosity of 33 seconds; after 2 hours, it was 32 seconds, and after 24 hours, it was 33 seconds. The gel point of the paste was 147-159° F.

The method is disclosed in a series of drawings shown below.

In addition, both of these examples can be combined with a woven bag, such as a burlap sack, which is filled with the combined slurry containing pre-mixed starch. The slurry is then marinated in the sack and infused into it, after which the sack is dried.

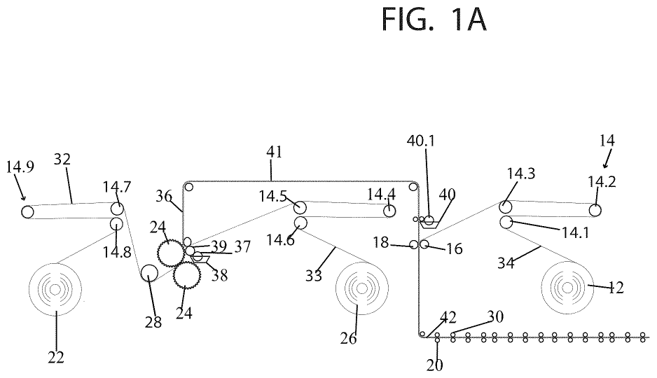

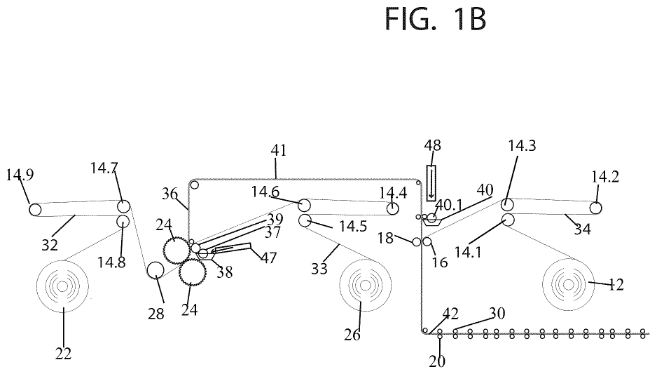

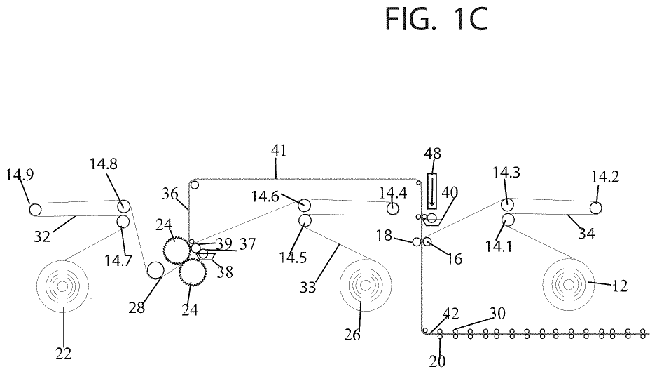

FIG. 1A is a view of the first embodiment components for making corrugated material for use in packaging with the coating or adhesive applied. For example, rollers 22, 14.7, 14.8 and 14.9, 28 and 24.1 and 24.2 are shown for handling a first sheet 32.

Sheet 34 can be controlled by rollers 12, 14.1, 14.2, and 14.3, as well as rollers 16 and 18.

Sheet 33 can also be controlled by rollers 26, 14.4, 14.5 and 14.6. This sheet 33 can be applied to sheet 32 after sheet 32 passes through rollers 24.1 and 24.2. Rollers 24.1 and 24.2 create a corrugated shape in the sheet. This joining occurs after roller 39 joins sheets 32 and 33.

The sheets can be of any suitable form such as paper sheets.

Rollers 37 and 39 are for applying the Cinnamon or Cinnamic Acid adhesive material and/or coating to at least one of the sheets. For example, roller 37 rotates in and/or around tray 38 which is filled with cinematic acid. This then coats roller 37 which rotates against roller 39. Roller 39 then applies the cinematic acid to the corrugated sheet 36 (formed from sheet 32). As such, trays 38, and 40 are configured to apply the adhesive insecticide material to at least one of the sheets.

Disposed adjacent to tray 40 is roller 40.1. Roller 40.1 rotates in and/or around tray 40 to apply the cinematic acid by applying this material to rollers 42 as well which press the material into the sheet combined sheet 41 which is combined from sheets 32 and 33 at roller 43. Rollers 42 are positioned on opposite sides of coated sheet 41. These trays can also be described as soaking trays.

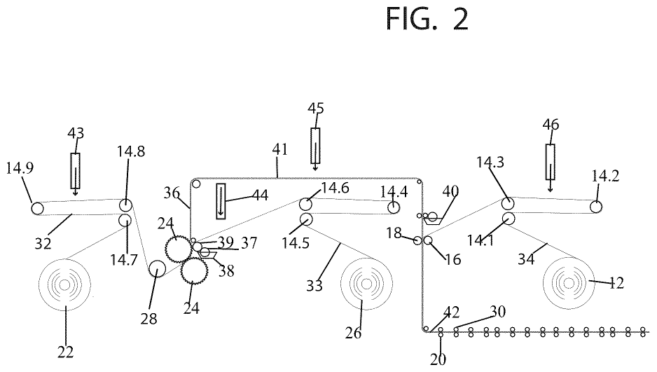

In addition, there are applicators or supply hoses 44, 45, 46,47, 48 (See FIGS. 1B-2) for supplying the Cinnamon or Cinnamic Acid adhesive and/or coating materials to the trays 38, 35, and 40, respectively. For example, FIG. 1B shows applicator 47 which is configured to spray cinematic acid into tray 38 while applicator 48 is configured to spray cinematic acid into tray 40.

In FIG. 1C there is only sprayer 48 which is configured to spray or dispense cinematic acid into tray 40.

Roller 24 including rollers 24.1 and 24.2 comprise a corrugated roller with teeth that can take a flat sheet, such as sheet 33, and turn it into a corrugated sheet. FIGS. 1B-2 shows alternatives to this embodiment. For example, FIG. 1A does not show sprayers 44-48 shown in FIG. 1B. FIG. 1C does not disclose sprayers 44-47 shown in FIG. 1B. FIG. 1D does not include the sprayer 47.

FIG. 2 is a view of another embodiment, which shows the same rollers 22, 14.7, 14.8, and 14.9 for handling sheet 32, as well as rollers 26, 14.4, 14.5 and 14.6 for handling sheet 33, and rollers 12, 14.1, 14.2, 14.3, and rollers 16 and 18 for handling sheet 34. In this embodiment, there are spray hoses or nozzles 43, 44, 45, and 46 for spraying the components of the natural biocide onto the sheets to form an additional coating. In this way, with the additional coating on the sheets, both on the inside via the trays, and on the outside of the sheets via the spray nozzle 44 as well as spray nozzle 46 to form a biocide coating on the outside of the sheets to further repel any unwanted growth via mold or fungus or to repel any outside pests such as mice, rats, ants cockroaches or any other pests.

Ultimately the finished sheet 42 which is formed from sheets 32, 33, and 34 is passed through rollers 20 and 30. Depending on the process used, the cinematic acid is either contained on the interior of the combined sheet 42 or also or in the alternative on at least one side of the finished combined sheet 42.

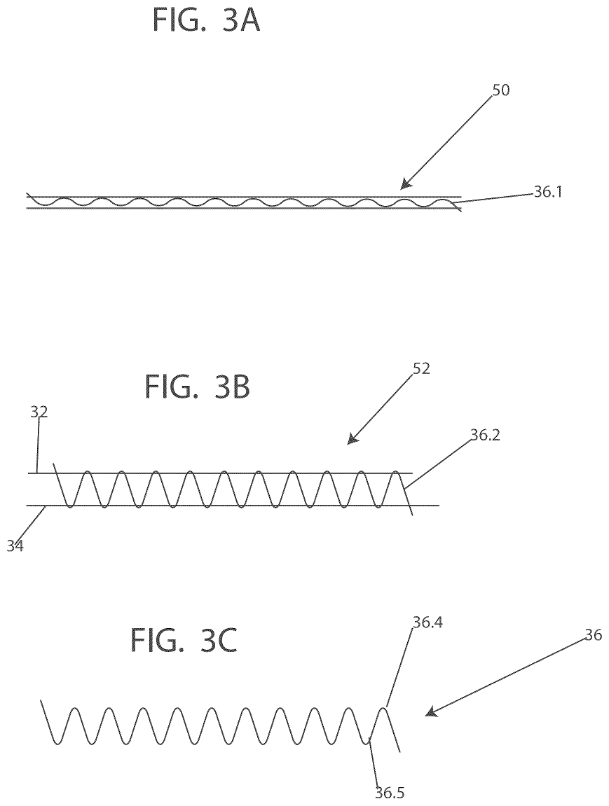

FIG. 3A is a view of the corrugated material 50, which is created via the combination of sheets, including sheets 32, 33, 34, and 36, which is a modified form of sheet 33.

FIG. 3B is another view of another embodiment of corrugated material, which shows that sheet 36.2 has a different flute profile formed by the corrugating process.

FIG. 3C is another view of the corrugated material with the outer covers removed, showing that the corrugated sheet 36 has peak 36.4 and trough 36.5, which can be coated with a coating material and/or Cinnamon or Cinnamic Acid adhesive before applying the outer sheets, such as sheets 32 and 34.

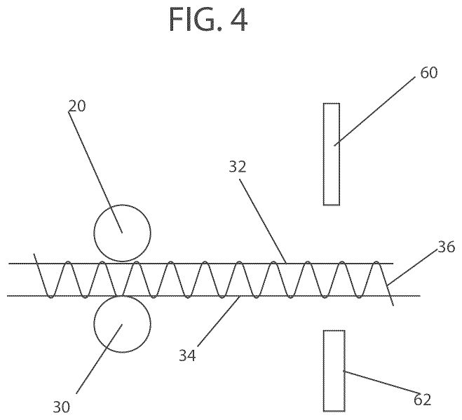

FIG. 4 is a view of the components for coating the outer covers of the corrugated material in an additional coating process. For example, sheets 32, 36, and 34 are shown in a sandwiched format. Rollers 20 and 30 are configured to apply pressure to the roll, while sprayers 60 and 62 are configured to apply an additional coating of biocide material, such as that shown in Example 1, to the material.

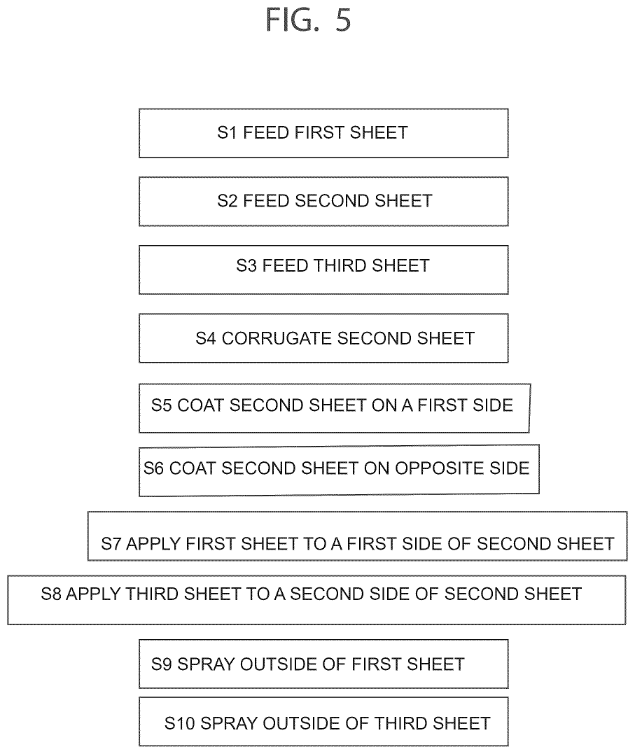

FIG. 5 is a view of the flow chart for applying the adhesive and/or coating to the packaging material. For example, the process starts in step S1, wherein the first sheet is fed into the system. This first sheet can be in the form of sheet 32. Next, in step S2 the second sheet 33 is fed into the system. Next, in step S3 the third sheet is fed into the system. Next, in step S4, the second sheet 33 is corrugated via a corrugating roller, such as roller 24. Next, in step S5, the system can coat the second sheet 33/36 on a first side. Next, in step S6, the system can coat the second sheet 33/36 on a second or opposite side. Next, in step S7, the system can apply the first sheet 32 to a first side of the second sheet 36. Next, in step S8, the system can apply a third sheet 34 to the second side of the second sheet 36. Next, in step S9, the system can spray the outside of the first sheet with a biocide such as the biocide described in example 1. Next, in step 10, the system can also spray a biocide on the outside of the third sheet.

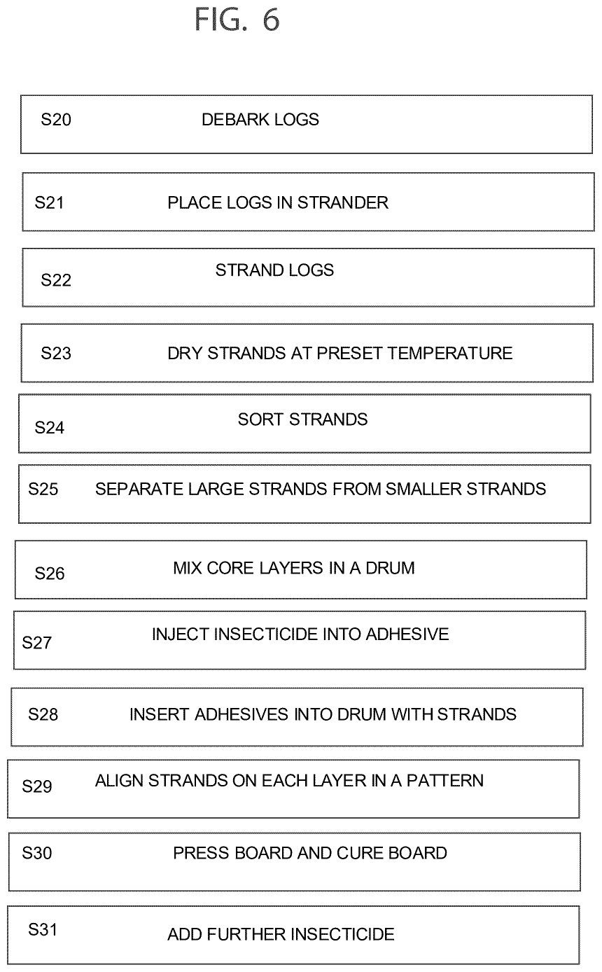

FIG. 6 is a flowchart for the process of creating oriented strand board. For example, the process starts with step S20, wherein logs are debarked. Next, in step S21, the logs are placed in the strander. Next, in step S22, the logs are stranded. Next, in step S23, the strands are dried at a preset temperature. Next, in step S24, the strands are sorted. Next, in step S25, the large strands are separated from the smaller strands.

Next, in step S26, the core layers are mixed in a drum. Next, in step S27, the insecticide, as disclosed above in Example 1, is injected into the adhesive. Next, in step S28, the adhesives are injected into the drum with strands to adhere the strands together. Next, the strands are aligned in a pattern on each layer. Next, the board is pressed and cured, which then cures the adhesive and the insecticide into the board. Next, in step S31, the insecticide shown in example 1 is added to the outside of the pressed and cured board.

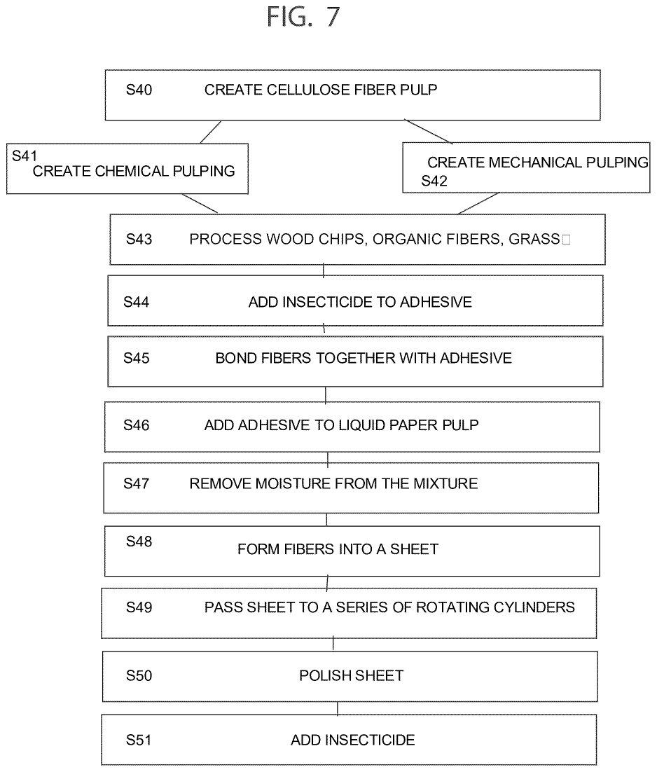

FIG. 7 is a view of the process for adding the insecticide directly to the paper pulp. This paper pulp can be formed using the adhesive shown in Example 2 and then injected with the insecticide from Example 1.

For example, the process begins in step S40, where cellulose fiber pulp is created. This pulp can be created in step S41 in a chemical process. Alternatively, in step S42, the pulp can be created mechanically. Next, the process proceeds to step S43, wherein the pulp is formed with wood chips, organic fibers, and grass. Next, in step S44, the insecticide of Example 1 is added to the adhesive to form the adhesive of Example 2. Next in step S45, the fibers are bound together with the adhesive. Next, in step S46, the adhesive is added to the liquid paper pulp. Next in step S47, the moisture is removed from the mixture. Next in step S48, the fibers are formed into a sheet. Next, in step S49, the sheet is passed to a series of rotating cylinders. Next, in step S50, the sheet is polished. Next, in step S51, the insecticide of Example 1 is then added to the fiber sheet. Thus, this fiber sheet can be both infused with insecticide through the adhesive and coated on the outside of the sheet with the insecticide of Example 1.

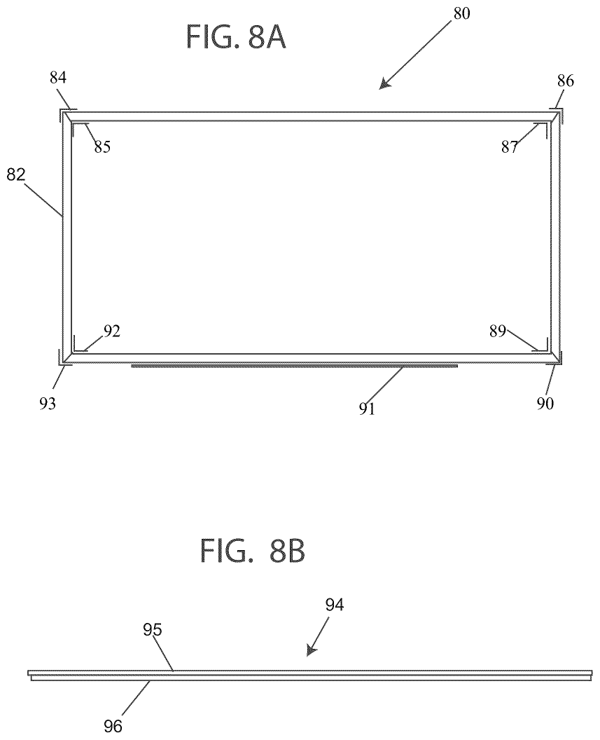

FIG. 8 is a top cross-sectional view of a box 80 for packaging, which has a box body 82. Box body 82 has a plurality of different adhesive strips 84, 85, in a first corner. There are also adhesive strips 86 and 87 in another corner. Furthermore, there are adhesive strips 89 and 90 in another corner. Furthermore, there is another corner which has adhesive strips 92 and 93. Strips 84, 85, 86, 87, 89, 90, 92, and 93 can be in the form of an adhesive tape that has the adhesive described in Example 2. Furthermore, a label 91 is shown, which can be applied to the body section 82 of the box via the adhesive described above in Example 2.

FIG. 8B is a side view of the adhesive strip 94. Adhesive strip 94 is essentially representative of strips 84, 85, 86, 87, 89, 90, 92, 93. This is also representative of label 91 as well. This strip 94, which includes the strip portion 95 and the adhesive portion 96. The adhesive portion, which is formed from the composition of Example 2, is used to adhere the strip 95 to the corners of the box 80 shown in FIG. 8A. Thus, there is created a packaging material that has a biocide that can be used as an adhesive and sprayed on both the inside of the sheets and the outside of the sheets to keep biological intrusion in the form of mold, fungus, or other naturally degrading components out of the packaging. In addition, the natural biocide can act as a repellent for pests such as cockroaches, rats, mice, ants, or other foreign invaders into the packaging.

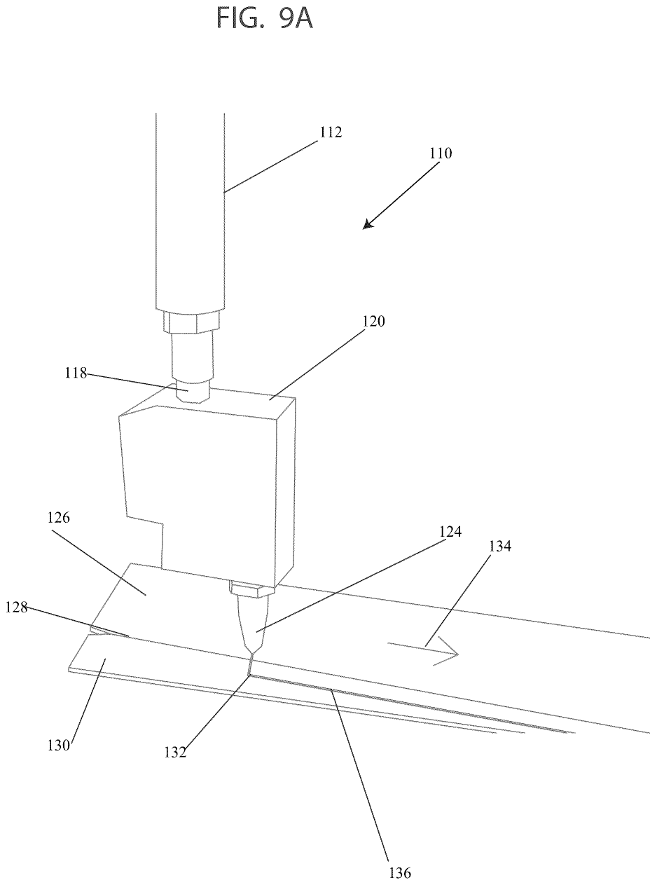

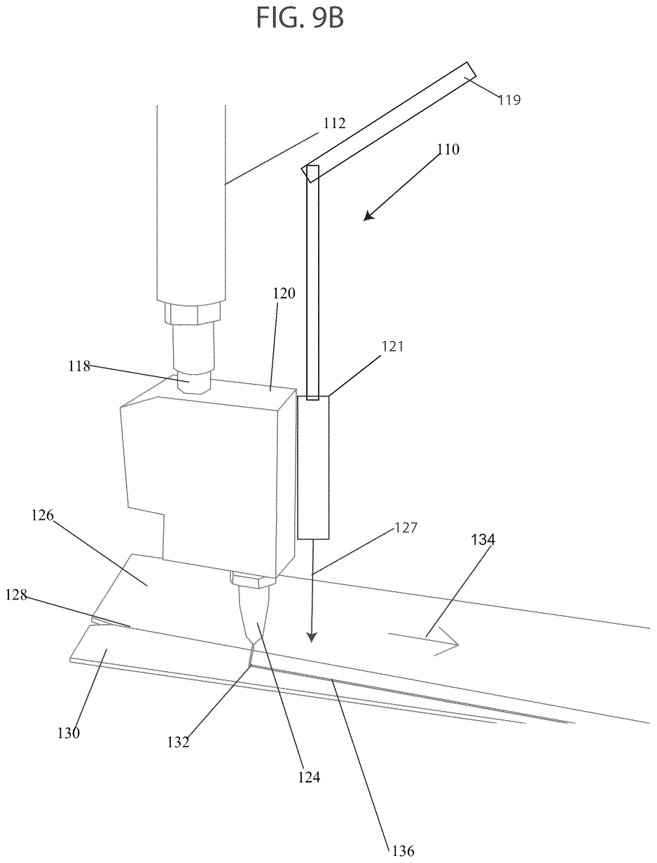

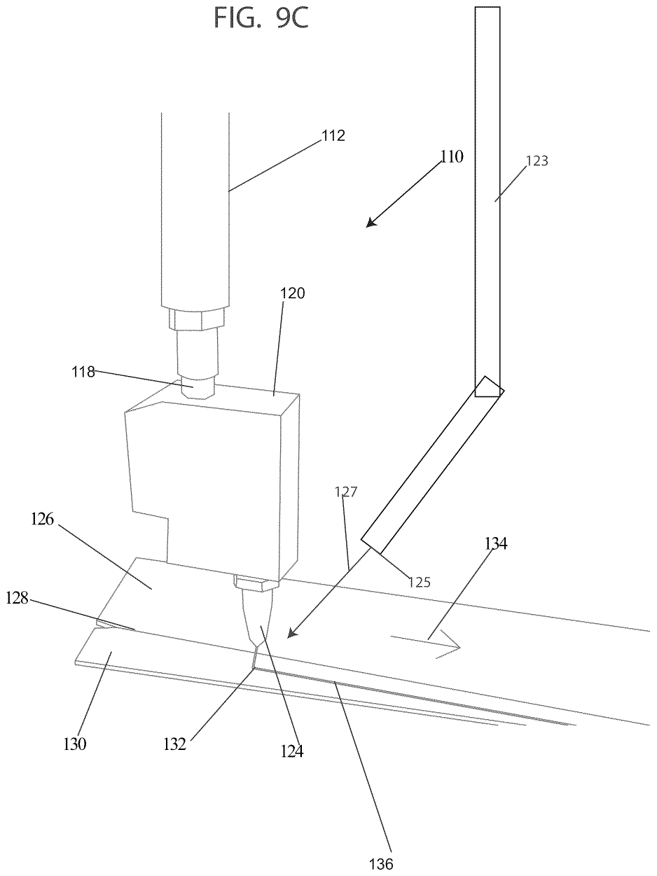

FIG. 9A is a side perspective view of the nozzle applicator. With this view, the applicator 110 is shown having a supply line 112 and a glue gun body 120. There is also an extrusion nozzle 124. The nozzle is configured to apply glue or adhesive to the side to be folded. On side 126 is a crease or perforation line 128. There is a glue flap 130 as well as the adhesive 132, which is shown being extruded along the direction of travel 134. The adhesive is shown being applied along line 136.

FIG. 9B is a side perspective view of another embodiment of the nozzle applicator, which shows the same components shown in FIG. 9A but also shows a feed line 119 for feeding cinnamic acid or other components, such as the natural insecticide disclosed in example 1, down line 119 and through second nozzle 121 to form a spray 127 onto the side 126 of the substrate. With this design, the separate applicator, including the second nozzle 121, can be used to separately apply the insecticide from the adhesive. In this way, the insecticide can be applied as needed and does not always require the use of all the adhesives.

FIG. 9C is another side perspective view of the nozzle applicator 110, which includes all the elements shown in FIG. 9A. In addition, there is also shown a separate line 123 which has a separate nozzle 125 for applying the insecticide, which is disclosed in example 1. Thus, with this design, the insecticide can be sprayed or applied separately.

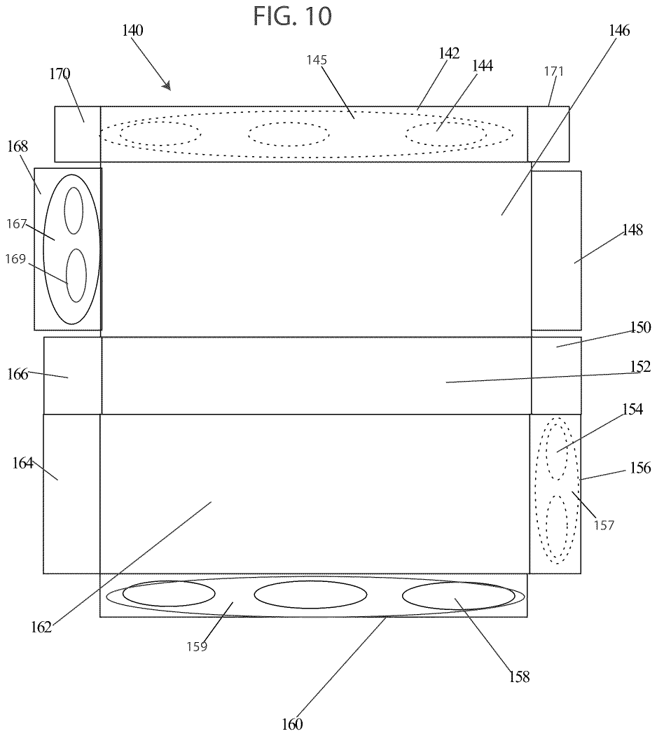

FIG. 10 is a view of a blank 140 which is set flat. Blank 140 serves as a blank from which packaging, such as a box, can be created. Blank 140 includes a first section 142, which has adhesive sections 144 positioned on an opposite side of the first section 142. A second section 146 is positioned adjacent to the first section 142. The second section 146 includes additional sections 148 and 168 formed as flaps. Additional section 168 has adhesive sections 169 disposed on the near side of this flap 168. Additional section 152 also includes flaps 150 and 166. It is noted that between each of these sections are lines that are formed as creases for folding between the sections. Another section 162 has flaps 164 and 156, with adhesive sections 154 disposed on the opposite side of flap 156. Furthermore, there is a flap 160, which has adhesive sections 158 disposed on the near side face of flap 160. While adhesive sections are illustrated, the adhesive may be applied in conjunction with the insecticide, as shown in Example 2; it may also be applied separately, as shown in Example 1. Therefore, optional regions for spraying insecticide are shown, indicated by region 145 on first section or flap 142, region 167 on flap 168, region 157 on flap 156, and region 159 on flap 160. These regions can optionally be designated for separately spraying the insecticide, separate from the adhesive, allowing the adhesive to be applied without the insecticide and the insecticide to be applied separately, for example, using a separate nozzle, such as nozzle 121 in FIG. 9B or nozzle 125 in FIG. 9C.

Thus, the adhesives applied in these adhesive sections can be used with the adhesives and/or components of any one of Examples 1 or 2. With Example 2, the starch-based adhesive, which may have previously attracted pests such as mice, rats, ants, or cockroaches, would now be repelled by the introduction of pesticides, such as those disclosed in Example 1 and/or Example 2.

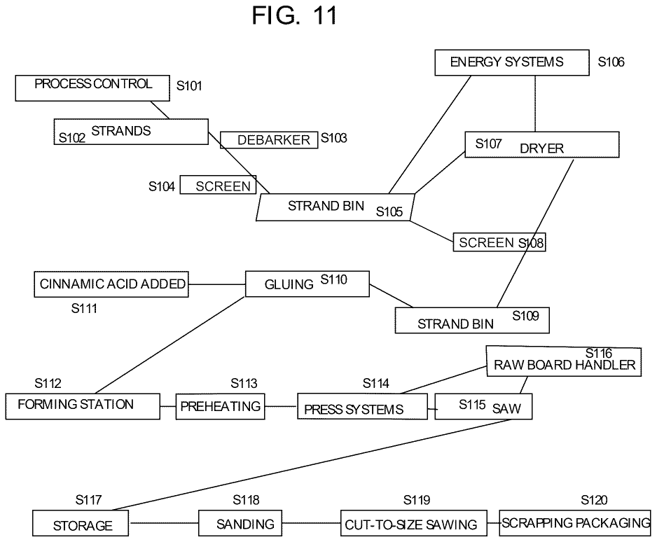

FIG. 11 is a process for treating or creating a plywood board that is infused with an antimicrobial or pesticide, such as cinnamic acid or other pesticide treatment. For example, this process includes a step of material control in step S101, which involves extracting strands of wood in step S102 from a debarker in step S103. These strands are then sent through a screen in step 104. Next, these strands are placed/stored in a strand bin in step S105. Next in step S106, there are energy systems that regulate the drying of these strands in step S107. Next, in step S108, the strands are further screened in a screen and then sent through an additional strand bin in step S109. Next, the strands from the strand bin 109 are then glued together in step S110. In step S111, cinnamic acid is injected into the glue for the gluing step, which occurs before the strands are glued together. Next, in step S112, the glued-together strands are sent to be formed into a board, such as in a forming station. Next, the materials are pre-heated in step S113. Next, in step S114, the materials are sent to press systems. These press systems press the boards together to form a specific sheet. Next, the sheets are sent to a saw and cut in step S115. Next, the cut boards are sent to the raw board handler in step S116. Next, in step S117, the boards are initially stored. Next, in step S118, the boards are sanded and finished. Next, in step S119, the boards are further cut to size. Next, in step S120, the scraps from the boards are sent for scrapping and then packaged. Thus, a board is created that is infused with a pesticide, such as cinnamic acid, which is incorporated into the board's particles or strands. Thus, with the cinnamic acid in the boards, it will repel other insects, such as cockroaches, ants, and termites.

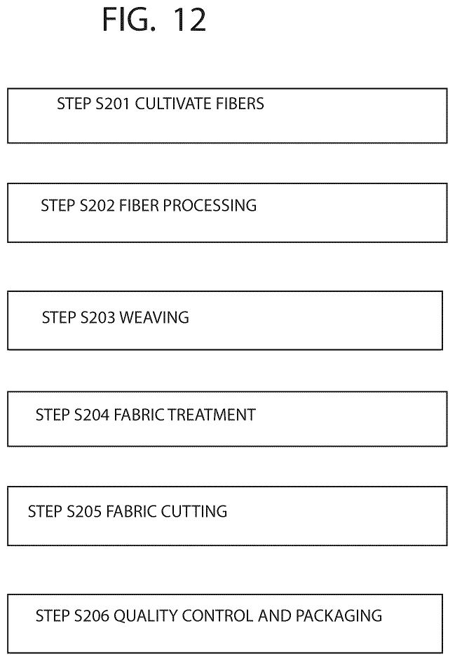

FIG. 12 is a process for applying cinnamic acid to a sack. For example, the process starts in step S201, which involves the cultivation and initial processing of the raw materials. The processing of the raw materials includes harvesting the crops, such as jute stalks, which are soaked in water to loosen the fibers. Next, the fibers are stripped, washed, and then dried.

Next, in step S202, the raw materials are processed into fiber. With this step, the dried fibers are treated with oil and water to further soften them. Next, the fibers are carded, aligning and cleaning them using machines to form long strands, or rovings. Next, the fibers are spun into yarn.

In step S203, the yarn is woven into a coarse, open weave fabric on industrial looms. This fabric is then known as burlap or hessian cloth.

Next, in step S204, the fabric is treated so that the woven burlap is washed or scoured to remove natural oils and dirt. Next, it is optionally dyed or treated for rot resistance, fire retardance, or water resistance. Next, it is washed or soaked with a cinnamic acid solution for antimicrobial and pesticide protection.

Next, in step S205, the treated burlap fabric is cut into the required sack dimensions. This fabric is then stitched using heavy-duty sewing machines. This stitching includes side seams, bottom hems, and sometimes drawstrings and closures.

Next, in step S206, the sacks undergo inspection for defects, tears, or weak seams. These sacks are then baled or bundled and shipped.

Thus, there is ultimately created packaging which can be in the form of cardboard packaging, particle board, or a sack which is infused with an insecticide that is non-toxic to humans, but which repels insects. This allows for the storage of food and/or materials inside an enclosure formed from cardboard, particle board, or sack without any risk to human contact.

Accordingly, while at least one embodiment of the present invention have been shown and described, it is to be understood that many changes and modifications may be made thereunto without departing from the spirit and scope of the invention as defined in the appended claims.

What is claimed is:

1. An insecticide solution comprising:
at least 1 wt. % cinnamic acid
at least one additional oil comprising at least one of tea tree oil, rosemary oil cedar oil, or powdered oregano oil.

2. The insecticide solution as in claim 1, wherein said at least one wt % cinnamic acid comprises at least 4% cinnamic acid.

3. The insecticide solution as in claim 2, wherein said cinnamic acid wt % comprises between 4 wt % and 11 wt %.

4. The insecticide solution as in claim 1, further comprising at least one starch base for combination with the solution.

5. The insecticide solution as in claim 4, wherein said starch base comprises at least 26% water.

6. The insecticide solution as in claim 5, further comprising borax.

7. The insecticide solution as in claim 6 wherein the starch has a wt % of at least 23 wt %.

8. The insecticide solution as in claim 1, wherein the solution is applied to an adhesive.

9. An adhesive comprising:
at least one starch base;
at least one insecticide comprising at least 1 wt % cinnamic acid and at least one additional oil comprising at least one of tea tree oil, rosemary oil, or cedar oil.

10. The adhesive as in claim 9, wherein the adhesive is in a form of a slurry.

11. The adhesive as in claim 9, wherein the starch base comprises corn starch.

12. The adhesive as in claim 11, further comprising boric acid.

13. The adhesive as in claim 12, further comprising sodium hydroxide.

14. The adhesive as in claim 13, wherein the at least 1 wt % of boric acid comprises at least 4 wt %.

15. A process for adding an adhesive having an insecticide comprising the following steps:
applying an adhesive to a soaking tray (40)
sending at least one first sheet through the soaking tray;
spraying said at least one sheet with an insecticide after applying adhesive to the sheet;
adhering said at least one first sheet to a second sheet to form an adhesion.

16. The process as in claim 15, wherein said second sheet is a corrugated sheet.

17. The process as in claim 16, further comprising applying at least one insecticide to said corrugated sheet.

18. The process as in claim 17, further comprising the set of applying an adhesive to said corrugated sheet.

19. The process as in claim 18, further comprising adhering at least one third sheet to the corrugated sheet.

20. A building material comprising:
at least one board wherein the board comprises a plurality of parts of the building material;
at least one adhesive for binding the parts of the building material together;
at least one insecticide coupled to at least one of the adhesive and parts of the building material wherein the insecticide comprises cinnamic acid.

21. The building material as in claim 20, wherein the insecticide comprises at least 1 wt % cinnamic acid.

22. The building material as in claim 21, wherein the insecticide further comprises boric acid.

23. The building material as in claim 22, wherein the insecticide further comprises at least one oil comprising at least one of tea tree oil, rosemary oil or cedar oil.
